(19) United States
(12) Patent Application Publication
(10) Pub. No.: US 2020/0134583 A1
(43) Pub. Date: Apr. 30, 2020

(54) FUND FLOW PROCESSING METHOD AND DEVICE

(71) Applicant: Alibaba Group Holding Limited, George Town (KY)

(72) Inventors: Danqing Hu, Hangzhou (CN); Xuebing Yan, Hangzhou (CN)

(73) Assignee: Alibaba Group Holding Limited, George Town (KY)

(21) Appl. No.: 16/725,619

(22) Filed: Dec. 23, 2019

Related U.S. Application Data
(63) Continuation of application No. 16/251,621, filed on Jan. 18, 2019.

(30) Foreign Application Priority Data
Jan. 19, 2018 (CN) 201810055277.2

(51) Int. Cl. G06Q 20/10; G06Q 40/02; G06Q 20/36; H04L 9/06

(52) U.S. Cl. CPC G06Q 20/108; G06Q 40/02; H04L 2209/38; H04L 9/0637; G06Q 20/102; G06Q 20/36

(57) ABSTRACT

A fund flow request for a specified amount between a payer and a payee is received by a first member of a blockchain. A fund flow route between the first member and a second member corresponding to the payee in the blockchain is determined, where the fund flow route includes the first member, the second member, and a number of relay members associated with the blockchain. A compliance check request to at least two other members included in the fund flow route is initiated, so that the at least two other members concurrently perform compliance checks on a fund flow event corresponding to the fund flow request. Whether each compliance check result generated by each member performing the compliance check is qualified is determined. In response to determining that each compliance check result is qualified, the fund flow event is completed.

### CROSS-REFERENCE TO RELATED APPLICATIONS

This application is a continuation of U.S. application Ser. No. 16/251,621, filed on Jan. 18, 2019, which claims priority to Chinese Patent Application No. 201810055277.2, filed on Jan. 19, 2018, each of which is hereby incorporated by reference in its entirety.

### TECHNICAL FIELD

One or more implementations of the present specification relate to the field of blockchain technologies, and in particular, to a fund flow method and apparatus, and an electronic device.

### BACKGROUND

In related technologies, fund flow between users, between a user and an enterprise, between enterprises, etc. is usually involved. A user or an enterprise that pays funds is a payer, a user or an enterprise that obtains funds is a payee. Fund flow is implemented between the payer and the payee.

When fund flow between the payer and the payee involves a plurality of financial institutions, the plurality of financial institutions need to sequentially perform a compliance check on the fund flow event. Even if only one financial institution's failed compliance check can lead the whole fund flow fails.

### SUMMARY

In view of this, one or more implementations of the present specification provide a fund flow method and apparatus, and an electronic device.

To achieve the previous objective, a technical solution provided in one or more implementations of the present specification is as follows:

According to a first aspect of the one or more implementations of the present specification, a fund flow method is provided, including: receiving, by a first member of a blockchain, a fund flow request for a specified amount between a payer and a payee; determining, by the first member, a fund flow route between the first member and a second member corresponding to the payee in the blockchain, where the fund flow route includes the first member, the second member, and several relay members from the blockchain; initiating, by the first member, a compliance check request to at least two members other than the first member in the fund flow route, so that the at least two members concurrently perform a compliance check on a fund flow event corresponding to the fund flow request; and initiating, by the first member, a fund flow contract operation when all compliance check results of the fund flow event of all members in the fund flow route are qualified, to complete the fund flow event based on the fund flow route.

According to a second aspect of the one or more implementations of the present specification, a fund flow method is provided, including: receiving, by a first member, a fund flow request for a specified amount between a payer and a payee; determining, by the first member, a fund flow route between the first member and a second member corresponding to the payee, where the fund flow route includes the first member, the second member, and several relay members; initiating, by the first member, a compliance check request to at least two members other than the first member in the fund flow route, so that the at least two members concurrently perform a compliance check on a fund flow event corresponding to the fund flow request; and completing, by the first member, the fund flow event based on the fund flow route when all compliance check results of the fund flow event of all members in the fund flow route are qualified.

According to a third aspect of the one or more implementations of the present specification, a fund flow apparatus is provided, including: a request receiving unit, configured to enable a first member of a blockchain to receive a fund flow request for a specified amount between a payer and a payee; a route determining unit, configured to enable the first member to determine a fund flow route between the first member and a second member corresponding to the payee in the blockchain, where the fund flow route includes the first member, the second member, and several relay members from the blockchain; a check initiation unit, configured to enable the first member to initiate a compliance check request to at least two members other than the first member in the fund flow route, so that the at least two members concurrently perform a compliance check on a fund flow event corresponding to the fund flow request; a result recording unit, configured to enable the first member to initiate a compliance evidence deposit contract operation, to record a compliance check result of the fund flow event in the blockchain; and a fund flow unit, configured to enable the first member to initiate a fund flow contract operation when all compliance check results of the fund flow event of all members in the fund flow route are qualified, to complete the fund flow event based on the fund flow route.

According to a fourth aspect of the one or more implementations of the present specification, a fund flow apparatus is provided, including: a request receiving unit, configured to enable a first member to receive a fund flow request for a specified amount between a payer and a payee; a route determining unit, configured to enable the first member to determine a fund flow route between the first member and a second member corresponding to the payee, where the fund flow route includes the first member, the second member, and several relay members; a check initiation unit, configured to enable the first member to initiate a compliance check request to at least two members other than the first member in the fund flow route, so that the at least two members concurrently perform a compliance check on a fund flow event corresponding to the fund flow request; and a fund flow unit, configured to enable the first member to complete the fund flow event based on the fund flow route when all compliance check results of the fund flow event of all members in the fund flow route are qualified.

According to a fifth aspect of the one or more implementations of the present specification, an electronic device is provided, including: a processor; and a memory that is configured to store an instruction that can be executed by the processor, where the processor is configured to implement the fund flow method according to any one of the previous implementations.

### BRIEF DESCRIPTION OF DRAWINGS

FIG. 1 is a flowchart illustrating a fund flow method, according to an example implementation;

FIG. 2 is a schematic diagram illustrating a remittance scenario, according to an example implementation;

FIG. 3 is a schematic diagram illustrating interaction in a cross-border remittance process, according to an example implementation;

FIG. 4 is a schematic diagram in which Wallet 1 receives remittance funds provided by user 1, according to an example implementation;

FIG. 5 is a schematic diagram in which a remittance route is determined, according to an example implementation;

FIG. 6 is a schematic diagram illustrating fund flow between members in a remittance route, according to an example implementation;

FIG. 7 is a schematic diagram in which Wallet 2 provides remittance funds for user 2, according to an example implementation;

FIG. 8 is a schematic diagram illustrating remittance implemented by transferring remittance funds to a blockchain balance, according to an example implementation;

FIG. 9 is a schematic diagram illustrating credit-based remittance, according to an example implementation;

FIG. 10 is a schematic diagram illustrating transaction information during fund settlement, according to an example implementation;

FIG. 11 is a schematic diagram illustrating water level recovery during fund settlement, according to an example implementation;

FIG. 12 is a schematic diagram illustrating water level adjustment based on historical change data during fund settlement, according to an example implementation;

FIG. 13 is a schematic diagram illustrating water level adjustment based on fund transaction prediction data during fund settlement, according to an example implementation;

FIG. 14 is a schematic structural diagram illustrating a device, according to an example implementation;

FIG. 15 and FIG. 16 are block diagrams illustrating a fund flow apparatus, according to an example implementation; and

FIG. 17 is a flowchart illustrating an example of a computer-implemented method for processing a fund flow, according to an implementation of the present disclosure.

### DESCRIPTION OF IMPLEMENTATIONS

Example implementations are described in detail here, and examples of the example implementations are presented in the accompanying drawings. When the following description relates to the accompanying drawings, unless specified otherwise, same numbers in different accompanying drawings represent same or similar elements. Implementations described in the following example implementations do not represent all implementations consistent with one or more implementations of the present specification. On the contrary, the implementations are only examples of apparatuses and methods that are described in the appended claims in detail and consistent with some aspects of one or more implementations of the present specification.

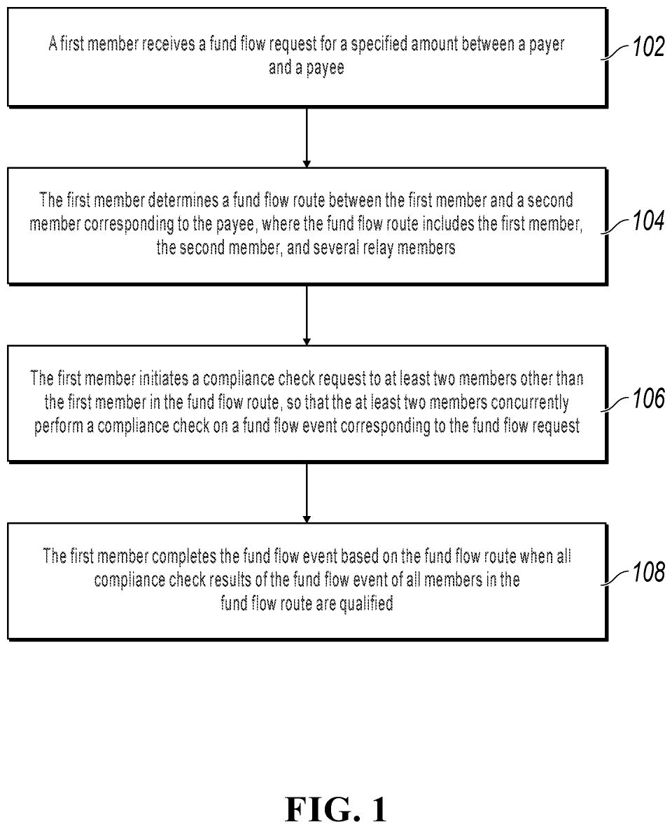

FIG. 1 is a flowchart illustrating a fund flow method, according to an example implementation. As shown in FIG. 1, the method can include the following steps.

Step 102: A first member receives a fund flow request for a specified amount between a payer and a payee.

In an implementation, the payer can initiate a payee-specified fund payment request. To be specific, the fund flow request received by the first member can be the fund payment request. For example, the fund payment request can be used by the payer for remittance or payment to the payee. Implementations are not limited in the present specification.

In an implementation, the payee can initiate a payer-specified fund receiving request. To be specific, the fund flow request received by the first member can be the fund receiving request. For example, the fund receiving request can be used by the payee to receive payment from the payer. Implementations are not limited in the present specification.

In an implementation, the payer and the payee can be individuals or organizations (for example, enterprises or platforms). Implementations are not limited in the present specification.

Step 104: The first member determines a fund flow route between the first member and a second member corresponding to the payee, where the fund flow route includes the first member, the second member, and several relay members.

In an implementation, a blockchain can store information about the first member, the second member, and the relay members that are in the fund flow route, and information about another member outside the fund flow route, and these members can be nodes in the blockchain. Nodes in the blockchain can further include several anchor points, and roles of the anchor points can be played by the previously described members, but are not limited to the previously described members.

In an implementation, a member in the fund flow route can be a financial institution, an organization or a platform in another form, etc. that supports a fund flow service. Implementations are not limited in the present specification. The financial institution is used as an example. Members in the fund flow route can belong to different institutions (for example, a plurality of banks), or can belong to different branches of the same institution (for example, a plurality of branches of the same bank). Implementations are not limited in the present specification.

In an implementation, each member in the blockchain network can deposit a certain amount of blockchain balances at each anchor point, and each anchor point is responsible for registering, in the blockchain, a blockchain balance deposited by each member at the anchor point. Information recorded by the anchor point can be broadcast to all other nodes for storage. When any change occurs on the blockchain balance, the anchor point also records corresponding change information in the blockchain and broadcasts the change information to all the other nodes. Because a distributed ledger technology is used in the blockchain, and each node stores full ledger information, all the nodes in the blockchain can be agreed by using a consensus algorithm, to jointly maintain a uniform ledger, namely, a blockchain ledger. Therefore, in the present specification, when a member or an anchor point reads or records “blockchain ledger” implementation information, the member or the anchor point reads or records implementation information of full ledger information stored by the member or the anchor point.

In an implementation, each member in the fund flow route is a member in the blockchain. There is an associated anchor point between adjacent members in the fund flow route. A blockchain balance deposited by an upstream member in the adjacent members at the associated anchor point is greater than a specified amount, to ensure that the blockchain balance is sufficient to pay funds that need to be paid. In addition, a downstream member sets the associated anchor point to be a trusted anchor point, to ensure that the downstream member can and is willing to receive funds at the associated anchor point.

Step 106: The first member initiates a compliance check request to at least two members other than the first member in the fund flow route, so that the at least two members concurrently perform a compliance check on a fund flow event corresponding to the fund flow request.

In an implementation, the compliance check can include at least one of the following: a Know Your Customer (KYC) check, an Anti-Money Laundering (AML) check, etc. Implementations are not limited in the present specification.

In an implementation, the first member can perform a compliance check on the fund flow event. The first member triggers determining of the fund flow route in step 104 when a compliance check result is qualified; or the first member determines that fund flow fails, and terminates the fund flow event when a compliance check result is unqualified.

In an implementation, the compliance check result obtained by the first member can be shared with the second member when the first member and the second member belong to the same institution. Therefore, the first member can initiate a compliance check request to all the relay members in the fund flow route, and does not need to send a compliance check request to the second member.

In an implementation, when the first member and the second member belong to different institutions, the first member initiates a compliance check request to the second member and all the relay members in the fund flow route, and the second member and the relay members need to independently perform compliance checks.

In an implementation, the compliance check request is initiated to the at least two members in the fund flow route at the same time, so that the at least two members can simultaneously start and concurrently perform compliance checks, to save more time than sequentially performed in series. It reduces time spent on the compliance checks and improves fund flow efficiency.

In an implementation, the first member can obtain to-be-checked documents of the fund flow event, and initiate a documents evidence deposit contract operation, to record a digital digest corresponding to the to-be-checked documents in the blockchain. The first member pushes the to-be-checked documents to the at least two members, so that the at least two members perform the compliance check. Then, after receiving the to-be-checked documents, at least one member can generate a corresponding digital digest, and compare the digital digest with the digital digest recorded by the first member in the blockchain, to determine whether the to-be-checked documents that are received by the at least one member is complete, so that incomplete or incorrect to-be-checked documents cannot be checked, and improve compliance check reliability. In addition, if there is a problem with the to-be-checked documents, the at least one member can request the correct to-be-checked documents from the first member in time, to improve compliance check efficiency.

In an implementation, the first member can request an initiator of the fund flow request to supplement documents when a compliance check result provided by at least one member is unqualified, and the initiator does not need to initiate the fund flow request again. Then, the first member can push obtained supplementary documents to the at least one member, so that the at least one member can perform a compliance check again.

The first member can determine that fund flow fails, and terminate the fund flow event when the number of requests for supplementing documents reaches the predetermined value, and a compliance check result returned by the at least one member is still unqualified.

Step 108: The first member completes the fund flow event based on the fund flow route when all compliance check results of the fund flow event of all members in the fund flow route are qualified.

In an implementation, a compliance check result provided by at least one member for the first member includes a digital digest corresponding to detailed data of a compliance check performed by the at least one member on the fund flow event, a determining result (for example, qualified or unqualified), and signature information of the at least one member. Because the detailed data of the compliance check includes content that cannot be disclosed, the at least one member can provide the digital digest only, and the detailed data is recorded only by the at least one member, to prevent private data from disclosing and perform tamper-resistance verification on the detailed data based on the digital digest, and ensure that the data can be traced.

In an implementation, the first member can record the compliance check results of the fund flow event in the blockchain. For example, the first member can initiate a compliance evidence deposit contract operation, to record the compliance check results in the blockchain. After the first member obtains a compliance check result generated by the first member or a compliance check result returned by another member, the first member can record the compliance check result in the blockchain when all the nodes in the blockchain agree on the compliance check result by using the consensus algorithm, in other words, when the compliance check result is approved by all the nodes. Due to the tamper-resistance feature of the blockchain, a compliance check result recorded in the blockchain can be reliable and credible enough, to facilitate subsequent reviewing and tracing.

In an implementation, when all the compliance check results of the fund flow event of all the members (the first member, the second member, and all the relay members) in the fund flow route are qualified, the first member can initiate a fund flow contract operation, and can complete the fund flow event based on the fund flow route after the fund flow contract operation takes effect.

In an implementation, a fund flow solution in the present specification can be applied to various fund flow scenarios, such as domestic fund flow and cross-border fund flow. Implementations are not limited in the present specification. A relatively large number of members are usually involved in a cross-border fund flow process. Therefore, fund flow efficiency can be significantly improved based on the fund flow solution in the present specification.

In an implementation, the blockchain in the present specification can be a consortium blockchain, and each member in the fund flow route is a consortium member of the consortium blockchain. In addition, the consortium blockchain can include other consortium members. Implementations are not limited in the present specification.

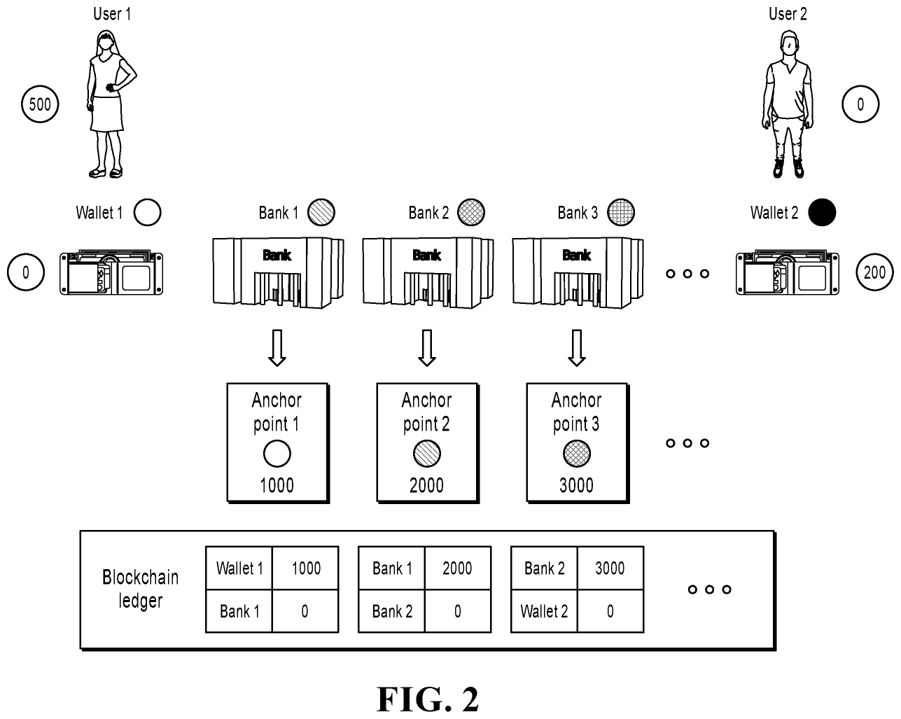

For ease of understanding, the following describes a technical solution in one or more implementations of the present specification by using a “cross-border remittance” process as an example. FIG. 2 is a schematic diagram illustrating a remittance scenario, according to an example implementation. As shown in FIG. 2, assume that, on a third-party payment platform, Wallet 1 operates in country A and Wallet 2 operates in country B. User 1 in country A opens customer capital account 1 in Wallet 1 and user 2 in country B opens customer capital account 2 in Wallet 2. A quick cross-border remittance can be implemented between user 1 and user 2 based on a fund flow solution in the present specification.

In an implementation, assume that Wallet 1, Wallet 2, Bank 1, Bank 2, Bank 3, etc. shown in FIG. 2 are all members in the same blockchain, and the blockchain can include several anchor points such as anchor point 1, anchor point 2, and anchor point 3 shown in FIG. 2. A role of an anchor point can be played by a member. For example, anchor points 1 to 3 in FIG. 2 respectively correspond to Banks 1 to 3. Certainly, a member is not mandatory to be the role of the anchor point, and the anchor point does not have to be a member neither. In other words, there is no necessary one-to-one mapping relationship between a member and an anchor point. Members such as Wallets 1 and 2 and Banks 1 to 3, anchor points 1 to 3, etc. are nodes in the blockchain, and the nodes implement distributed ledger technology in the blockchain.

To implement remittance between user 1 and user 2 by using each member in the blockchain, a contract corresponding to a “remittance” service needs to be added in advance to Wallets 1 and 2, Banks 1 to 3, etc. For example, the contract is referred to as a remittance contract here. Each member can deposit any amount of funds at each anchor point, namely, a blockchain balance deposited by the member at a corresponding anchor point. For example, a blockchain balance of Wallet 1 deposited at anchor point 1 is 1000 yuan, a blockchain balance of Bank 1 deposited at anchor point 2 is 2000 yuan, and a blockchain balance of Bank 2 deposited at anchor point 3 is 3000 yuan. After joining the remittance contract, each member is constrained by the remittance contract, so that a blockchain balance deposited by each member at each anchor point is registered by the corresponding anchor point in a blockchain ledger of the blockchain. A plurality of (usually greater than four) ledger nodes maintain one uniform distributed ledger in the blockchain, and a blockchain balance owned by each member at each anchor point is recorded in the ledger. Account book content recorded at all ledger nodes is consistent through inter-node broadcast and by using a consensus algorithm, and is full ledger information in the blockchain. Therefore, it can be considered that all the nodes in the blockchain use a uniform ledger, namely, the previously described blockchain ledger. Because of the tamper-resistance and traceability features of information in the blockchain, information registered in the blockchain ledger can be reliable enough, and can be trusted by all members and anchor points, and therefore can be used as an operation basis in various fund flow scenarios such as fund transfer and payment.

In addition, when joining the remittance contract, each member records respective trustiness in each anchor point in the remittance contract for a subsequent route determining process. For example, as shown in FIG. 2, no blockchain balance of Wallet 2 is deposited at anchor point 3. However, because Wallet 2 sets anchor point 3 to be a trusted anchor point, “a blockchain balance is 0” is used to represent trustiness in FIG. 2, and it indicates that Wallet 2 is willing to receive a blockchain balance of another member from anchor point 3. However, anchor point 1 and anchor point 2 can be untrusted anchor points of Wallet 2, and it indicates that Wallet 2 is unwilling to receive a blockchain balance of another member from anchor point 1 and anchor point 2.

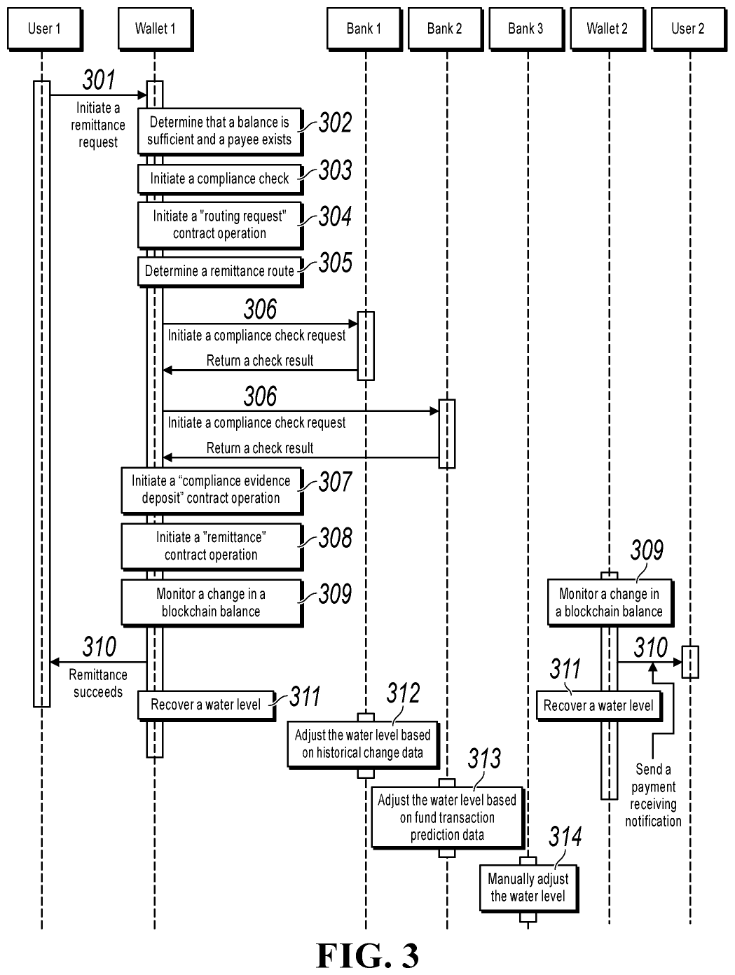

Based on the remittance scenario shown in FIG. 2, FIG. 3 is a schematic diagram illustrating interaction in a cross-border remittance process, according to an example implementation. As shown in FIG. 3, a process of interaction between users 1 and 2, Wallets 1 and 2, Banks 1 to 3, a blockchain, etc. can include the following steps.

Step 301: Wallet 1 receives a remittance request initiated by user 1.

In an implementation, user 1 can specify an amount of funds that need to be remitted and a payee in the remittance request. For example, assume that user 1 specifies that the amount of fund is 100 yuan and the payee is user 2. In addition to a method in which user 1 initiates the remittance request, a remittance process can be triggered by using another method in another scenario. For example, user 1 initiates a payment request that an amount of fund is 100 yuan and a payee is user 2. For another example, user 2 initiates a payment receiving request that an amount of fund is 100 yuan and a payer is user 1. Implementations are not limited in the present specification.

Step 302: Wallet 1 determines that a balance in a customer capital account 1 corresponding to user 1 is sufficient, and confirms with Wallet 2 that the payee user 2 exists.

In an implementation, FIG. 2 shows that the balance in customer capital account 1 corresponding to user 1 is 500 yuan, and is greater than 100 yuan that needs to be transferred. Therefore, it is determined that the balance is sufficient. However, when the balance is less than 100 yuan that needs to be transferred, it indicates that the balance is insufficient, and Wallet 1 can directly terminate remittance, and return a remittance failure notification message to user 1.

In an implementation, Wallet 1 can send payee information to Wallet 2, and Wallet 2 determines whether the payee information is valid. The payee information can include a payee name, a payee account number, a bank of the account number, etc. Implementations are not limited in the present specification. After verifying validity of the payee information, Wallet 2 can return a corresponding verification result to Wallet 1. When determining that the payee does not exist, Wallet 1 can directly terminate remittance, and return a remittance failure notification message to user 1.

Step 303: Wallet 1 can perform a compliance check on a remittance event initiated by user 1 to user 2.

In an implementation, Wallet 1 can provide a documents submission entry for user 1, and user 1 provides to-be-checked documents for the remittance event. User 1 can submit static documents in advance (for example, a photo of an identification card of user 1) that can be used for all remittance events, and submit dynamic documents (for example, a recent remittance record) for a corresponding remittance event each time remittance is implemented, to improve remittance efficiency.

In an implementation, the compliance check performed by Wallet 1 on the remittance event can include at least one of the following types: a KYC check, an AML check, etc. Implementations are not limited in the present specification.

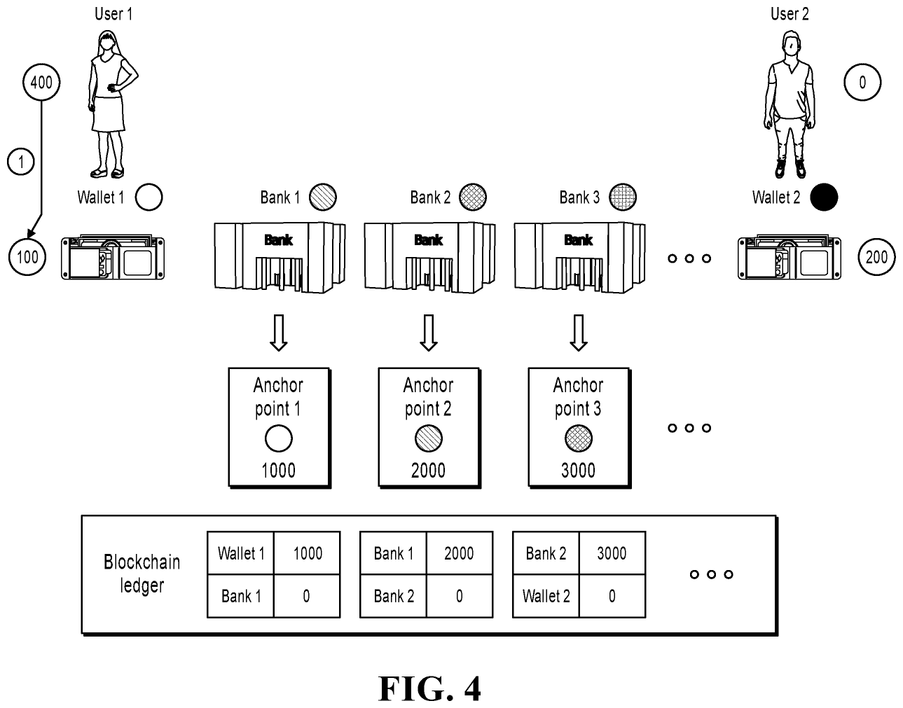

In an implementation, if a compliance check result obtained by Wallet 1 is unqualified, Wallet 1 can directly terminate remittance, and return a remittance failure notification message to user 1; or Wallet 1 can provide user 1 with at least one documents supplementing opportunity. For example, Wallet 1 can provide user 1 with a maximum of two opportunities. If the number of documents supplementation times of user 1 is greater than 2, and a compliance check result is still unqualified, Wallet 1 can terminate remittance, and return a remittance failure notification message to user 1. However, if a compliance check result obtained by Wallet 1 is qualified, as shown in FIG. 4, Wallet 1 can deduct 100 yuan from customer capital account 1 corresponding to user 1, and transfer 100 yuan to self-owned account 1 of Wallet 1.

Step 304: Wallet 1 initiates a “routing request” contract operation.

Step 305: Wallet 1 determines a remittance route.

In an implementation, after joining a remittance contract, a member in the blockchain can invoke several contract operations supported by the remittance contract, for example, the “routing request” contract operation here. The contract operation is used to determine a remittance route of remittance from user 1 to user 2, to implement a remittance operation.

In an implementation, the remittance route includes Wallet 1 that is the most upstream member, Wallet 2 that is the most downstream member, and several relay members between Wallet 1 and Wallet 2. In a technical solution based on the present specification, with the help of a blockchain balance deposited by each member in the remittance route at an anchor point in the blockchain, and transfer between blockchain balances, “remittance fund (for example, 100 yuan that user 1 expects to remit)” flow from Wallet 1 to Wallet 2, so that Wallet 2 finally provides the remittance funds for user 2.

When the remittance fund flows between members in the remittance route, there can be several times of fund flow between adjacent members, such as fund flow between Wallet 1 and a relay member, fund flow between relay members, and fund flow between a relay member and Wallet 2. For example, when the remittance route is “Wallet 1->relay member 1->relay member 2->Wallet 2”, there are three pairs of adjacent members: “Wallet 1->relay member 1”, “relay member 1->relay member 2”, and “relay member 2->Wallet 2, and there are three times of fund flow from Wallet 1 to relay member 1, from relay member 1 to relay member 2, and from relay member 2 to Wallet 2. Fund flow between each pair of adjacent members needs to be implemented by using the anchor point in the blockchain, and there are two conditions: Condition 1: A blockchain balance deposited by an upstream member in adjacent members at an anchor point is greater than a remittance amount; Condition 2: A downstream member in adjacent member sets the anchor point to be a trusted anchor point. In other words, there is an associated anchor point between an upstream member and a downstream member, a blockchain balance of the upstream member at the associated anchor point is sufficient for fund flow, and the downstream member is willing to receive flowing blockchain funds from the associated anchor point.

Wallet 1 can read the previous blockchain ledger by using full ledger information stored in Wallet 1, to learn a blockchain balance deposited by each member such as Banks 1 to 3 at each anchor point such as anchor points 1 to 3, and can determine whether each member satisfies Condition 1 and Condition 2 with reference to recorded trusted anchor points corresponding to each member in the contract, to further determine the remittance route.

Wallet 1 and Bank 1 are used as an example: A blockchain balance of wallet 1 deposited at anchor point 1 is 1000 yuan, and is greater than a remittance amount of 100 yuan, and Bank 1 sets anchor point 1 to be a trusted anchor point. Therefore, anchor point 1 is an associated anchor point between Wallet 1 and Bank 1, and Wallet 1 and Bank 1 can implement fund flow based on anchor point 1.

Bank 1 and Bank 3 are used as an example: There is no blockchain balance of Bank 1 deposited at anchor point 1 (because anchor point 1 is a trusted anchor point of Bank 1, it can be understood that the blockchain balance is 0), and a blockchain balance deposited at anchor point 2 is 2000 yuan. The blockchain balance of Bank 1 deposited by at anchor point 2 is greater than a remittance amount of 100 yuan, and anchor point 2 is an untrusted anchor point specified by Bank 3. Therefore, there is no associated anchor point between Bank 1 and Bank 3, and fund flow cannot be implemented. However, Bank 1 and Bank 2 are used as another example: A blockchain balance of Bank 1 deposited at anchor point 2 is 2000 yuan, and is greater than a remittance amount of 100 yuan, and Bank 2 sets anchor point 2 to be a trusted anchor point. Therefore, anchor point 2 is an associated anchor point between Bank 1 and Bank 2, and Bank 1 and Bank 2 can implement fund flow based on anchor point 2.

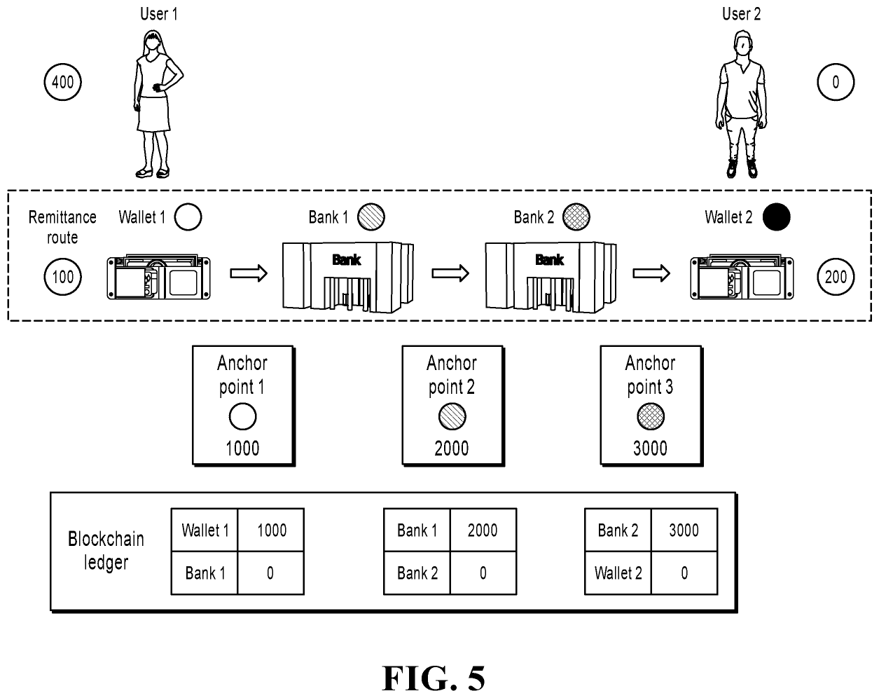

Similarly, whether each member in the blockchain satisfies Condition 1 and Condition 2 can be separately determined based on the previously described method, to determine that several relay members between the Wallet 1 and the Wallet 2 can be connected in series to obtain the complete remittance route. For example, FIG. 5 is a schematic diagram in which a remittance route is determined, according to an example implementation. As shown in FIG. 5, the remittance route can include Wallet 1->Bank 1->Bank 2->Wallet 2, an associated anchor point between Wallet 1 and Bank 1 is anchor point 1, an associated anchor point between Bank 1 and Bank 2 is anchor point 2, and an associated anchor point between Bank 2 and Wallet 2 is anchor point 3.

In an implementation, Wallet 1 can simultaneously determine a plurality of remittance routes, and select a final remittance route based on a specific condition. For example, the condition can include the shortest path or the lowest cost. Implementations are not limited in the present specification.

Step 306: Wallet 1 initiates a compliance check request to all relay members in the remittance route.

In an implementation, when Wallet 1 and Wallet 2 belong to the same third-party payment platform, because Wallet 1 has completed the compliance check in step 303, the compliance check result is also applicable to Wallet 2, and Wallet 2 does not need to perform a compliance check again. In another implementation, Wallet 1 and Wallet 2 can belong to different third-party payment platforms. Therefore, Wallet 1 can simultaneously initiate the compliance check request to all the relay members and Wallet 2 in step 306, so that all the relay members and Wallet 2 perform a compliance check. For ease of description, that Wallet 2 does not need to independently perform a compliance check is used as an example for description in the following.

In an implementation, members use different compliance check methods, and therefore, the members need to independently perform a compliance check on the to-be-checked documents of user 1. Wallet 1 initiates a compliance check request to both Bank 1 and Bank 2 at the same time, so that Bank 1 and Bank 2 can concurrently initiate a compliance check on the remittance event instead of performing a compliance check in series by the relay members, to g reduce time for the compliance check on the remittance event and improve compliance check efficiency.

In an implementation, Wallet 1 can push the to-be-checked documents provided by user 1 to Bank 1 and Bank 2, so that Bank 1 and Bank 2 perform the compliance check based on the to-be-checked documents, for example, the previous KYC check and AML check. To ensure integrity and reliability of the to-be-checked documents in a pushing process, Wallet 1 can generate a digital digest corresponding to the to-be-checked documents before pushing, and record the digital digest in the blockchain by invoking a “documents evidence deposit” contract operation. In addition, after receiving the pushed to-be-checked documents, Bank 1 and Bank 2 can read the digital digest from the blockchain, and compare the digital digest with a digital digest of the received to-be-checked documents. If the digital digests are the same, Bank 1 and Bank 2 determines that the to-be-checked documents is complete and reliable; otherwise, Bank 1 and Bank 2 determines that there is a problem with the to-be-checked documents, and Wallet 1 needs to provide the to-be-checked documents again.

In an implementation, after completing a compliance check, any member in the remittance route can return a corresponding check result to Wallet 1. The check result can include a digital digest corresponding to detailed data of the compliance check performed by the any member, a determining result (qualified or unqualified), and signature information (indicating that the check result is from the any member) of the any member. The detailed data corresponding to the digital digest included in the check result is related to private information of user 1, user 2, etc., a non-disclosed rule of the compliance check performed by the any member, etc. Therefore, only the digital digest is included in the check result, and the specific detailed data is recorded only by the any member for subsequent verification or checks performed by a regulatory authority.

It is worthwhile to note that compared with the compliance check performed by Wallet 1 in step 303, a compliance check performed by each relay member in step 306 is more important and necessary. In some scenarios, the compliance check performed by Wallet 1 in step 303 can even be omitted, but the compliance check performed by each relay member in step 306 is usually necessary.

Step 307: Wallet 1 initiates a “compliance evidence deposit” contract operation, to record an obtained check result in a blockchain ledger.

In an implementation, by initiating the “compliance evidence deposit” contract operation, Wallet 1 can record check results returned by Bank 1, Bank 2, etc. in the blockchain corresponding to Wallet 1, and further broadcast the check results to another node in the blockchain for recording. In other words, Wallet 1 records the check results in the previous blockchain ledger. Because of tamper-resistance and traceability features of a blockchain, the check results are reliable enough, and can be called and reviewed by the regulatory authority.

Similarly, for the check result obtained in step 303, Wallet 1 can also initiate the “compliance evidence deposit” contract operation, to record the check result in the blockchain ledger for subsequent calling and reviewing.

In an implementation, when a check result returned by any member is unqualified, Wallet 1 can provide user 1 with at least one documents supplementing opportunity. After obtaining supplementary documents, Wallet 1 can provide the supplementary documents for the any member, so that the any member performs a compliance check again. Wallet 1 can record a digital digest of the supplementary documents in the blockchain ledger, so that the any memory compares a digital digest of a received supplementary documents with the digital digest recorded in the blockchain ledger, to determine whether the received supplementary documents is reliable. Assume that Wallet 1 can provide user 1 with a maximum of two opportunities. If the number of documents supplementation times of user 1 is greater than 2, and a check result returned by the any member is still unqualified, Wallet 1 can terminate remittance, and return a remittance failure notification message to user 1.

In an implementation, if Wallet 1 does not receive a returned check result in a predetermined time length (for example, two minutes) after initiating the compliance check request to Bank 1 and Bank 2, Wallet 1 can determine that the check result is unqualified. Therefore, Wallet 1 records the check result “unqualified” in the blockchain ledger by invoking the “compliance evidence deposit” contract operation, and in addition, returns a remittance failure notification message to user 1.

Step 308: When compliance check results of both Bank 1 and Bank 2 are qualified, Wallet 1 initiates a “remittance” contract operation, to perform fund flow between members in the remittance route.

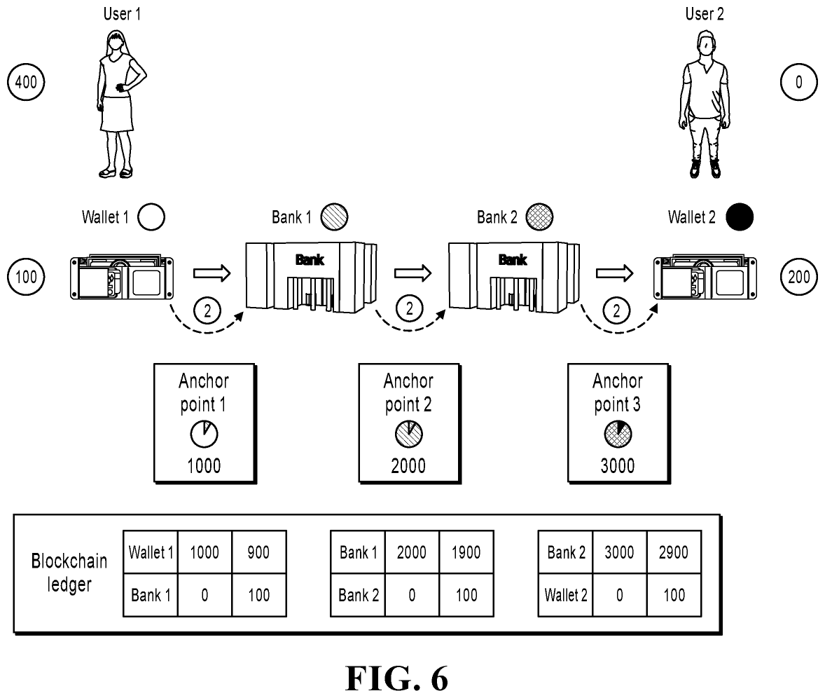

In an implementation, before the “remittance” contract operation takes effect, blockchain balances shown in FIG. 5 are recorded in the blockchain ledger. A blockchain balance of Wallet 1 deposited at anchor point 1 is 1000 yuan, a blockchain balance of Bank 1 deposited at anchor point 2 is 2000 yuan, and a blockchain balance of Bank 2 deposited at anchor point 3 is 3000 yuan. After the “remittance” contract operation takes effect, fund flow is sequentially performed between Wallet 1, Bank 1, Bank 2, and Wallet 2 in the remittance route, as shown in FIG. 6.

Fund flow is implemented between Wallet 1 and Bank 1 by using anchor point 1, and 100 yuan flows from a blockchain balance of Wallet 1 deposited at anchor point 1 to a blockchain balance of Bank 1 deposited at anchor point 1, so that the blockchain balance of Wallet 1 deposited at anchor point 1 is reduced from 1000 yuan to 900 yuan, and the blockchain balance of Bank 1 deposited at anchor point 1 is increased from 0 yuan to 100 yuan.

Fund flow is implemented between Bank 1 and Bank 2 by using anchor point 2, and 100 yuan flows from a blockchain balance of Bank 1 deposited at anchor point 2 to a blockchain balance of Bank 2 deposited at anchor point 2, so that the blockchain balance of Bank 1 deposited at anchor point 2 is reduced from 2000 yuan to 1900 yuan, and the blockchain balance of Bank 2 deposited at anchor point 2 is increased from 0 yuan to 100 yuan.

Fund flow is implemented between Bank 2 and Wallet 2 by using anchor point 3, and 100 yuan flows from a blockchain balance of Bank 2 deposited at anchor point 3 to a blockchain balance of Wallet 2 deposited at anchor point 3, so that the blockchain balance of Bank 2 deposited at anchor point 3 is reduced from 3000 yuan to 2900 yuan, and the blockchain balance of Bank 2 deposited at anchor point 3 is increased from 0 yuan to 100 yuan.

In previous processes of fund flow between Wallet 1 and Bank 1, fund flow between Bank 1 and Bank 2, and fund flow between Bank 2 and Wallet 2: because 100 yuan is transferred from customer capital account 1 of user 1 to self-owned account 1 of Wallet 1, and the blockchain balance of Wallet 1 deposited at anchor point 1 is reduced by 100 yuan, a net fund flow amount of Wallet 1 is 0; because the blockchain balance of Bank 1 deposited at anchor point 1 is increased by 100 yuan, and the blockchain balance of Bank 1 deposited at anchor point 2 is reduced by 100 yuan, a net fund flow amount of Bank 1 is 0; because the blockchain balance of Bank 2 deposited at anchor point 2 is increased by 100 yuan, and the blockchain balance of Bank 2 deposited at anchor point 3 is reduced by 100 yuan, a net fund flow amount of Bank 2 is 0; and because the blockchain balance of Wallet 2 deposited at anchor point 3 is increased by 100 yuan, 100 yuan remitted by user 1 flows to the blockchain balance of Wallet 2 through the remittance route.

It is worthwhile to note that all nodes in the blockchain use a uniform blockchain ledger, in other words, blockchain balances of all members at each anchor point are recorded in the blockchain ledger. Therefore, the blockchain balance of Wallet 1 deposited at anchor point 1, the blockchain balances of Bank 1 separately deposited at anchor point 1 and anchor point 2, the blockchain balances of Bank 2 separately deposited at anchor point 2 and anchor point 3, and the blockchain balance of Wallet 2 deposited at anchor point 3 can be simultaneously and uniformly adjusted in the blockchain, so that the blockchain balance of Wallet 1 is reduced by 100 yuan, the blockchain balance of Wallet 2 is increased by 100 yuan, and a blockchain balance of each relay member is unchanged.

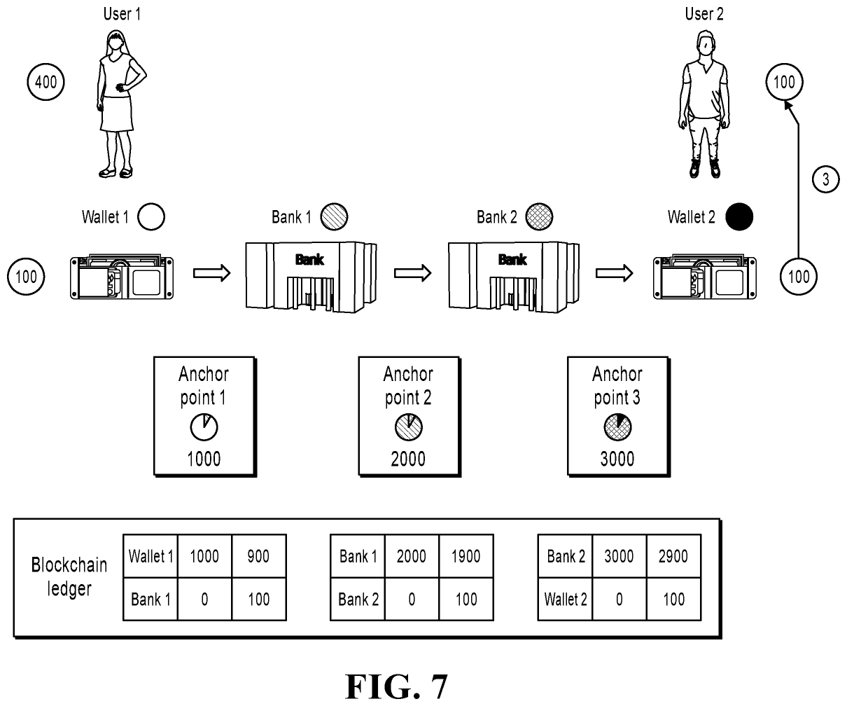

As shown in FIG. 7, 100 yuan can be transferred from self-owned account 2 of Wallet 2 to customer capital account 2 opened by user 2 in Wallet 2. Because 100 yuan is added to the blockchain balance of Wallet 2 deposited at anchor point 3, a final net fund flow amount of Wallet 2 is 0 yuan, and user 2 obtains 100 yuan remitted from user 1.

Step 309: Wallet 1 and Wallet 2 separately monitor a change in a blockchain balance.

Step 310: Wallet 1 sends a remittance success notification to user 1, and Wallet 2 sends a payment receiving notification to user 2.

It is worthwhile to note that in the previous implementation, self-owned account 1 is opened in Wallet 1, self-owned account 2 is opened in Wallet 2, fund transfer is performed between self-owned account 1 of Wallet 1 and customer capital account 1 of user 1 to obtain the remittance fund provided by user 1, and fund transfer is performed between self-owned account 2 of Wallet 2 and customer capital account 2 of user 2 to provide the remittance funds for user 2. In addition, a fund change in the blockchain balance of Wallet 1 and a fund change in the blockchain balance of Wallet 2 independently occur, provided that a net fund flow amount between a self-owned account and a blockchain balance is 0. However, there is another processing method in another implementation, as described below.

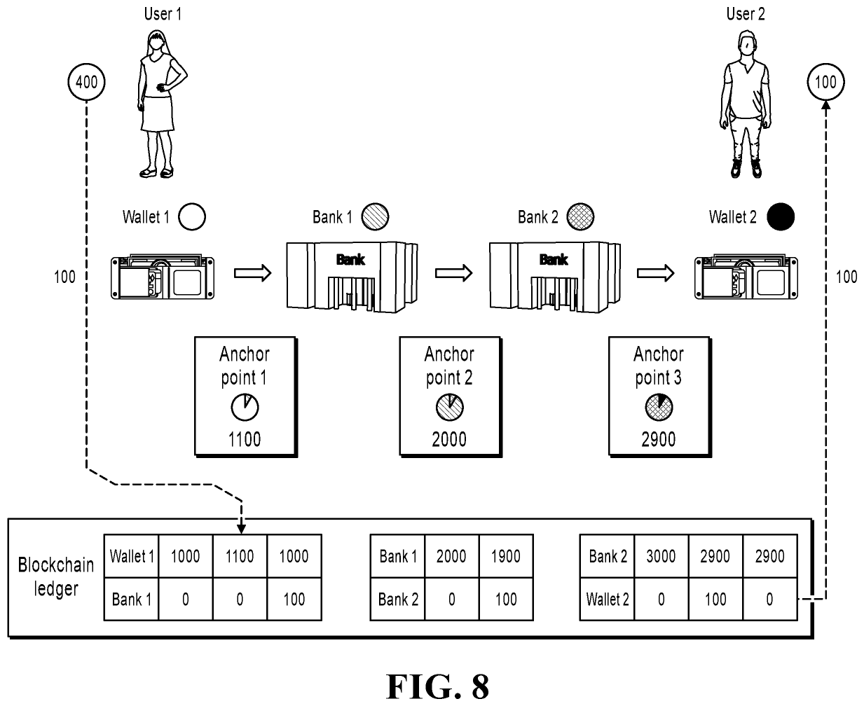

FIG. 8 is a schematic diagram illustrating remittance implemented by transferring remittance funds to a blockchain balance, according to an example implementation. As shown in FIG. 8, it can be seen that based on change information of a blockchain balance recorded in the blockchain ledger, an initial blockchain balance of Wallet 1 deposited at anchor point 1 is 1000 yuan, and after user 1 initiates the user 2-specified remittance request, 100 yuan is extracted from customer capital account 1 corresponding to user 1 to Wallet 1, and the extracted 100 yuan is deposited in the blockchain balance of Wallet 1 deposited at anchor point 1, so that the blockchain balance of Wallet 1 at anchor point 1 is increased to 1100 yuan. Then, Wallet 1 invokes the “remittance” contract operation, so that the blockchain balance of Wallet 1 deposited at anchor point 1 is reduced from 1100 yuan to 1000 yuan, and the blockchain balance of Bank 1 deposited at anchor point 1 is increased from 0 yuan to 100 yuan. In addition, 100 yuan sequentially flows between Bank 1, Bank 2, and Wallet 2 based on the implementation shown in FIG. 7, so that the blockchain balance of Wallet 2 deposited at anchor point 3 is increased from 0 yuan to 100 yuan. Finally, 100 yuan of Wallet 2 deposited at anchor point 3 is withdrawn and transferred to customer capital account 2 of user 2, to complete remittance from user 1 to user 2. Based on the previous process, self-owned account 1 and self-owned account 2 do not need to be opened in Wallet 1 and Wallet 2, and instead, funds provided by user 1 are directly deposited in the blockchain balance, and are used for fund flow in the blockchain.

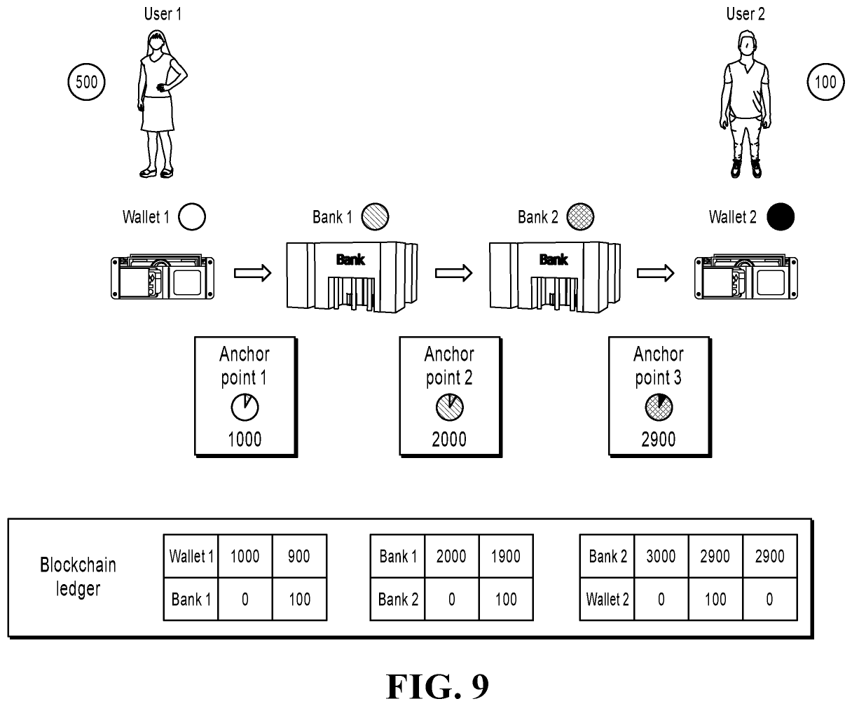

FIG. 9 is a schematic diagram illustrating credit-based remittance, according to an example implementation. As shown in FIG. 9, it can be seen that based on change information of a blockchain balance recorded in the blockchain ledger, an initial blockchain balance of Wallet 1 deposited at anchor point 1 is 1000 yuan, and after user 1 initiates the user 2-specified remittance request, based on credit of Wallet 1 to user 1, Wallet 1 can advance funds for the remittance operation of user 1, and user 1 subsequently performs repayment. Therefore, based on fund flow between Wallet 1, Bank 1, Bank 2, and Wallet 2, the blockchain balance of Wallet 1 deposited at anchor point 1 is reduced from 1000 yuan to 900 yuan, the net fund flow amount is reduced by 100 yuan, and the net fund flow amount of Bank 1, the net fund flow amount of Bank 2, and all the net fund flow amounts of Bank 1, Bank 2, and Wallet 2 are 0 yuan. For a specific fund flow process, references can be made to the previous implementation. Details are omitted here for simplicity.

Step 311: After daily settlement, Wallet 1 and Wallet 2 perform water level recovery on respective blockchain balance deposited at each anchor point.

In an implementation, each member in the blockchain performs fund settlement based on a predetermined period. For example, the predetermined period can be one day, three days, or one week. Implementations are not limited in the present specification. For example, the predetermined period is one day. Each member performs fund settlement at a specific moment (for example, 18:00) each day, namely, daily settlement. Because the blockchain balance changes with transaction, as if a water level in a bucket changes, adjustment of the blockchain balance can be vividly referred to as “water level” adjustment.

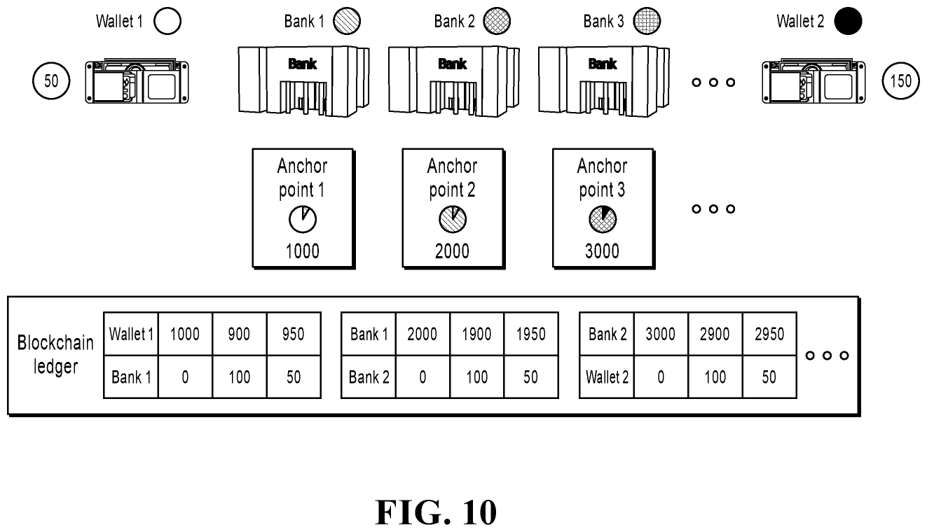

For example, FIG. 10 is a schematic diagram illustrating transaction information during fund settlement, according to an example implementation. As shown in FIG. 10, assume that Wallets 1 and 2 and Banks 1 to 3 are involved in two transactions in total on the current day. The first transaction is that user 1 remits 100 yuan to user 2, and the second transaction is that user 2 remits 50 yuan to user 1. Therefore, it can be determined, during settlement, that a remaining blockchain balance of Wallet 1 deposited at anchor point 1 is 950 yuan, a blockchain balance of Bank 1 deposited at anchor point 1 is 50 yuan, the blockchain balance of Bank 1 deposited at anchor point 2 is 1950 yuan, the blockchain balance of Bank 2 deposited at anchor point 2 is 50 yuan, the blockchain balance of Bank 2 deposited at anchor point 3 is 2950 yuan, the blockchain balance of Wallet 2 deposited at anchor point 3 is 50 yuan, and so on.

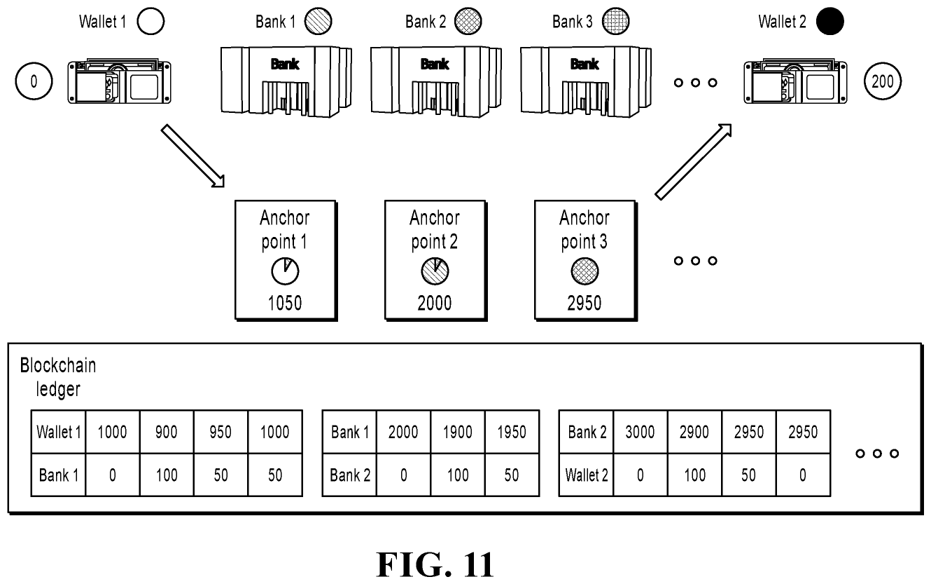

Based on information about a fund transaction between members that is recorded in the blockchain ledger, it can be determined that the blockchain balance of Wallet 1 deposited at anchor point 1 changes from 1000 yuan to 900 yuan, and changes from 900 yuan to 950 yuan. Therefore, a final change is that a net fund change amount is 950-1000=−50 yuan. In other words, 50 yuan is reduced. Therefore, 50 yuan can be transferred from self-owned account 1 of Wallet 1 to the blockchain balance of Wallet 1 deposited at anchor point 1 (a balance of self-owned account 1 is correspondingly reduced from 50 yuan to 0 yuan), so that the blockchain balance is reverted from 950 yuan to 1000 yuan, and change information of the blockchain balance is recorded by anchor point 1 in the blockchain ledger. Details are shown in FIG. 11. Wallet 1 can initiate a fund depositing contract operation, to transfer 50 yuan from self-owned account 1 to the blockchain balance deposited at anchor point 1.

Similarly, based on the information about the fund transaction between members that is recorded in the blockchain ledger, it can be determined that the blockchain balance of Wallet 2 deposited at anchor point 3 changes from 0 yuan to 100 yuan, and changes from 100 yuan to 50 yuan. Therefore, a final change is that a net fund change amount is 50−0=50 yuan. In other words, 50 yuan is added. Therefore, 50 yuan can be withdrawn from the blockchain balance of Wallet 2 deposited at anchor point 1 to self-owned account 2 of Wallet 2 (a balance of self-owned account 2 is corresponding increased from 150 yuan to 200 yuan), so that the blockchain balance is reverted from 50 yuan to 0 yuan, and change information of the blockchain balance is recorded by anchor point 3 in the blockchain ledger. Details are shown in FIG. 11. Wallet 2 can initiate a fund withdrawing contract operation, to withdraw 50 yuan from the blockchain balance deposited at anchor point 1 to self-owned account 2.

Step 312: Perform water level adjustment on a blockchain balance of Bank 1 based on historical change data.

In an implementation, Bank 1 can read all transactions involving Bank 1 from the blockchain ledger, to obtain the historical change data of Bank 1. Therefore, Bank 1 can predict a change in a blockchain balance at each anchor point on the next day based on full historical change data or historical change data in a specific time period (for example, in the last three days, in the last week, and on Mondays of the last five weeks), to perform water level adjustment on the blockchain balance based on the change.

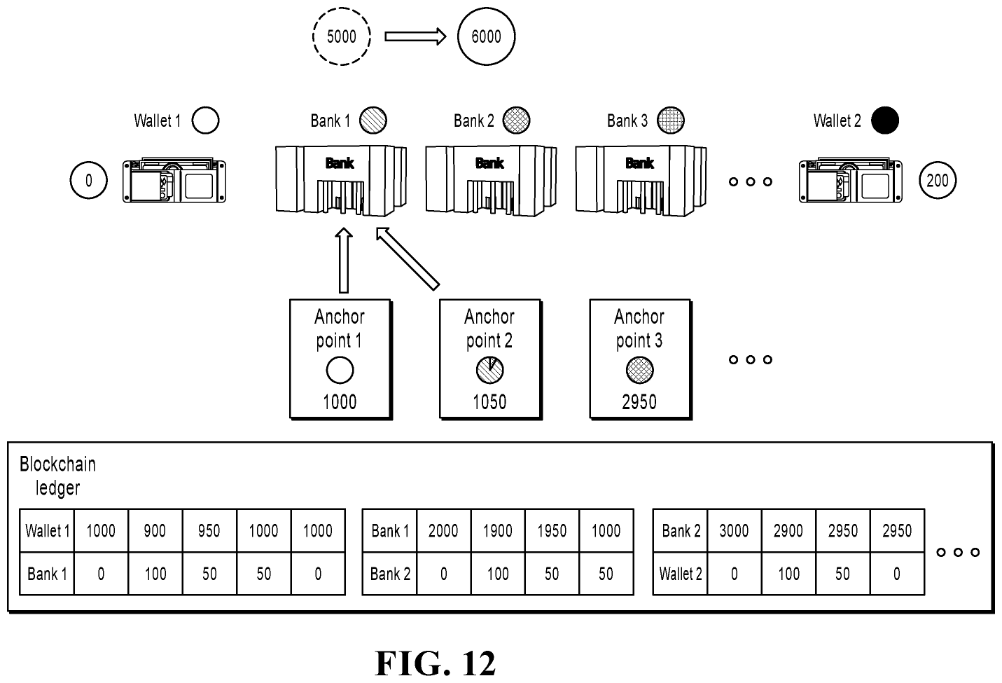

For example, when the historical change data indicates that a net fund change amount does not exceed 100 yuan when an initial amount of the blockchain balance of Bank 1 at anchor point 1 is 0, and a net fund change amount does not exceed 1000 yuan when an initial amount of the blockchain balance at anchor point 2 is 2000. As shown in FIG. 12, a difference between the initial amount 0 yuan at anchor point 1 and the value 100 yuan is relatively small, and the blockchain balance of Bank 1 at anchor point 1 can be kept to be 0 yuan. Therefore, 50 yuan needs to be withdrawn from the blockchain balance deposited at anchor point 1 to a self-owned account of Bank 1, so that the blockchain balance of Bank 1 at anchor point 1 is reverted to 0 yuan. For example, Bank 1 can initiate a fund withdrawing contract operation, to withdraw 50 yuan from the blockchain balance at anchor point 1 to the self-owned account of Bank 1. A difference between the initial amount 2000 yuan at anchor point 2 and the value 1000 yuan is relatively large, and the blockchain balance of Bank 1 at anchor point 2 can be adjusted to 1000 yuan. Therefore, 950 yuan needs to be withdrawn from the blockchain balance deposited at anchor point 2 to the self-owned account of Bank 1, and the blockchain balance of Bank 1 at anchor point 2 is reduced to 1000 yuan. For example, Bank 1 can initiate a fund withdrawing contract operation, to withdraw 950 yuan from the blockchain balance at anchor point 2 to the self-owned account of Bank 1.

It can be seen from the implementations shown in FIG. 11 and FIG. 12 that in a water level adjustment process, adjustment can be performed between a blockchain balance and a self-owned account of a member.

Step 313: Perform water level adjustment on a blockchain balance of Bank 2 based on fund transaction prediction data.

In an implementation, Bank 2 can read information such as all transactions occurring in a whole network from the blockchain ledger, and generate corresponding fund transaction prediction data based on the information, for example, a transaction in the whole network on the next day, or at least a change in the blockchain balance of Bank 2 on the next day, to perform water level adjustment on the blockchain balance. Certainly, the fund transaction prediction data does not have to be generated by Bank 2, and can be from another member, an anchor point, the blockchain, or any object. Implementations are not limited in the present specification.

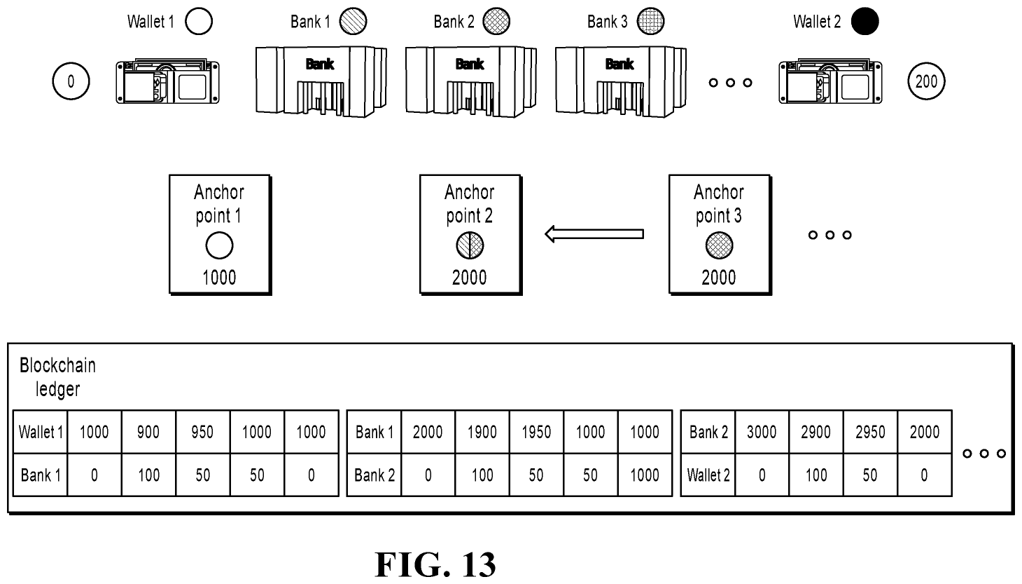

For example, as shown in FIG. 13, assume that Bank 2 predicts that a net fund change amount at anchor point 2 on the next day is approximately 1000, and a net fund change amount at anchor point 3 is less than 2000. Therefore, Bank 2 can transfer 950 yuan from the blockchain balance of Bank 2 deposited at anchor point 3 to the blockchain balance deposited at anchor point 2. For example, Bank 2 can initiate a fund withdrawing contract operation, to withdraw 950 yuan from the blockchain balance deposited at anchor point 3, and then initiate a fund depositing contract operation, to deposit 950 yuan to the blockchain balance deposited at anchor point 2, so that the blockchain balance deposited at anchor point 2 is increased to 1000 yuan, and the blockchain balance deposited at anchor point 3 is reduced to 2000 yuan, thereby satisfying fund change demands at anchor point 2 and anchor point 3 on the next day.

It can be seen from the implementation shown in FIG. 13 that in the water level adjustment process, adjustment can be performed between blockchain balances at a plurality of anchor points.

Step 314: Manually adjust a blockchain balance of Bank 3.

In an implementation, each member can use any one of or a combination of the previous solutions (for example, a water level recovery solution is used for blockchain balances at some anchor points, and water level adjustment is performed for blockchain balances at the other anchor points based on the historical change data) such as water level recovery, water level adjustment based on the historical change data, water level adjustment based on the fund transaction prediction data, and manual water level adjustment. Implementations are not limited in the present specification.

In an implementation, a member can invoke a “balance adjustment” contract operation, to perform water level adjustment on a blockchain balance of the member at each anchor point. The “balance adjustment” contract operation can include the previous fund depositing contract operation, the fund withdrawing contract operation, etc. In addition to adjustment between blockchain balances and adjustment between a blockchain balance and a self-owned account, if the member obtains credit from an anchor point, the “balance adjustment” contract operation can instruct the anchor point to adjust, based on the credit, a blockchain balance deposited by the member (in other words, to register a value change in the blockchain balance in the blockchain ledger).

It is worthwhile to note that there can be a plurality of types of blockchains in the present specification, and implementations are not limited in the present specification. For example, when the blockchain is a consortium chain, each member in the remittance route is a consortium member of the consortium chain, to ensure that the member has corresponding operation authority.

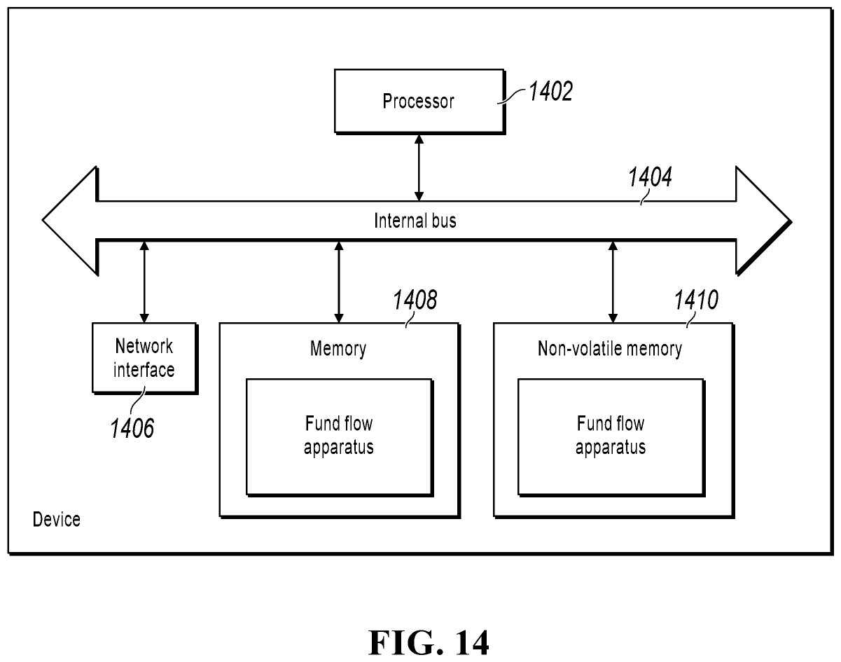

FIG. 14 is a schematic structural diagram illustrating a device, according to an example implementation. Referring to FIG. 14, in terms of hardware, the electronic device includes a processor 1402, an internal bus 1404, a network interface 1406, a memory 1408, and a nonvolatile memory 1410, and certainly can further include hardware needed by other services. The processor 1402 reads a corresponding computer program from the nonvolatile memory 1410 to the memory 1408 for running, and a fund flow apparatus is logically formed. Certainly, in addition to a software implementation, one or more implementations of the present specification do not exclude another implementation, for example, a logic device or a combination of hardware and software. In other words, an execution body of the following processing procedure is not limited to each logical unit, and can also be hardware or a logic device.

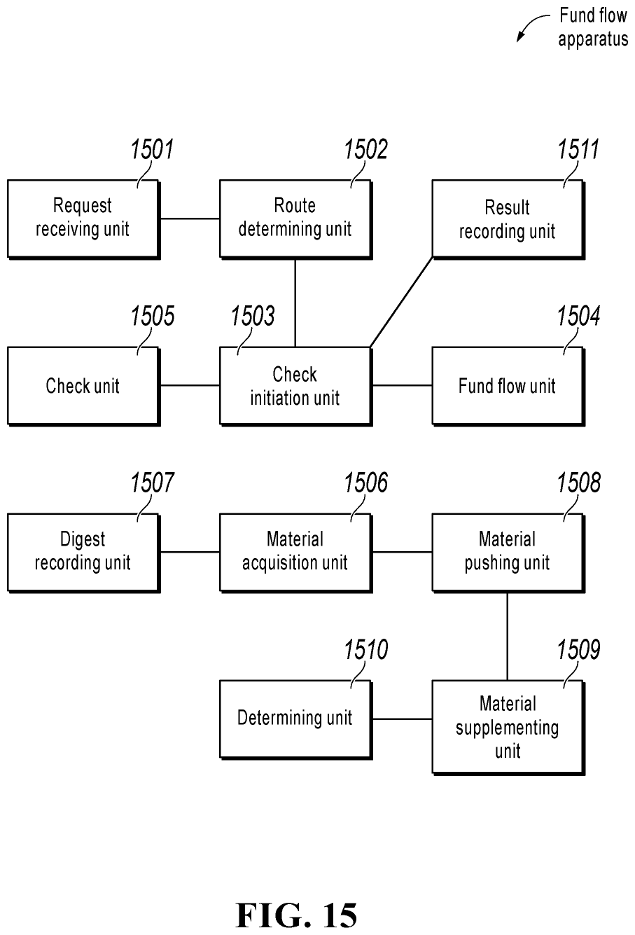

In an implementation, referring to FIG. 15, in the software implementation, the fund flow apparatus can include: a request receiving unit 1501, configured to enable a first member of a blockchain to receive a fund flow request for a specified amount between a payer and a payee; a route determining unit 1502, configured to enable the first member to determine a fund flow route between the first member and a second member corresponding to the payee in the blockchain, where the fund flow route includes the first member, the second member, and several relay members from the blockchain; a check initiation unit 1503, configured to enable the first member to initiate a compliance check request to at least two members other than the first member in the fund flow route, so that the at least two members concurrently perform a compliance check on a fund flow event corresponding to the fund flow request; and a fund flow unit 1504, configured to enable the first member to initiate a fund flow contract operation when all compliance check results of the fund flow event of all members in the fund flow route are qualified, to complete the fund flow event based on the fund flow route.

Optionally, the apparatus further includes: a check unit 1505, configured to enable the first member to perform a compliance check on the fund flow event; and enable the first member to trigger, by using the route determining unit 1502, determining of the fund flow route when a compliance check result is qualified; or enable the first member to determine that fund flow fails, and terminate the fund flow event when a compliance check result is unqualified.

Optionally, the check initiation unit 1503 is configured to enable the first member to initiate a compliance check request to all relay members in the fund flow route when the first member and the second member belong to the same institution; or enable the first member to initiate a compliance check request to the second member and all relay members in the fund flow route when the first member and the second member belong to different institutions.

Optionally, the apparatus further includes: a documents acquisition unit 1506, configured to enable the first member to obtain to-be-checked documents of the fund flow event; a digest recording unit 1507, configured to enable the first member to initiate a documents evidence deposit contract operation, to record a digital digest corresponding to the to-be-checked documents in the blockchain; and a documents pushing unit 1508, configured to enable the first member to push the to-be-checked documents to the at least two members, so that the at least two members perform the compliance check.

Optionally, the apparatus further includes: a documents supplementing unit 1509, configured to enable the first member to request an initiator of the fund flow request to provide supplement documents when a compliance check result provided by at least one member is unqualified, where the documents pushing unit 1508 is further configured to enable the first member to push obtained supplementary documents to the at least one member, so that the at least one member performs a compliance check again.

Optionally, the apparatus further includes: a determining unit 1510, configured to enable the first member to determine that fund flow fails, and terminate the fund flow event when the number of requests for supplementing documents reaches the predetermined value, and a compliance check result returned by the at least one member is still unqualified.

Optionally, a compliance check result provided by at least one member for the first member includes a digital digest corresponding to detailed data of a compliance check performed by the at least one member on the fund flow event, a determining result, and signature information of the at least one member; and the detailed data is recorded by the at least one member.

Optionally, the compliance check includes at least one of the following: a KYC check and an anti-money laundering check.

Optionally, the apparatus further includes: a result recording unit 1511, configured to enable the first member to record the compliance check results of the fund flow event in the blockchain, where the fund flow unit 1501 is configured to enable the first member to initiate the fund flow contract operation when all compliance check results that are of the fund flow event of all members in the fund flow route and that are recorded in the blockchain are qualified.

Optionally, the result recording unit 1511 is configured to enable the first member to initiate a compliance evidence deposit contract operation, to record the compliance check results of the fund flow event in the blockchain.

Optionally, fund flow between the first member and the second member based on the fund flow request is cross-border fund flow.

Optionally, fund flow between the first member and the second member based on the fund flow request is remittance, payment, or payment receiving.

Optionally, the blockchain is a consortium chain, and each member in the fund flow route is a consortium member of the consortium chain.

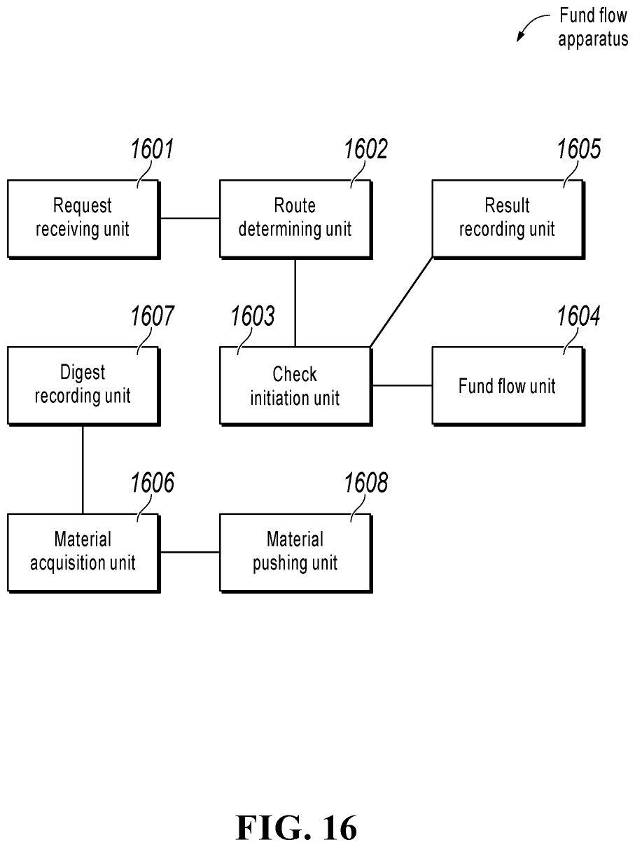

In another implementation, referring to FIG. 16, in the software implementation, the fund flow apparatus can include: a request receiving unit 1601, configured to enable a first member to receive a fund flow request for a specified amount between a payer and a payee; a route determining unit 1602, configured to enable the first member to determine a fund flow route between the first member and a second member corresponding to the payee, where the fund flow route includes the first member, the second member, and several relay members; a check initiation unit 1603, configured to enable the first member to initiate a compliance check request to at least two members other than the first member in the fund flow route, so that the at least two members concurrently perform a compliance check on a fund flow event corresponding to the fund flow request; and a fund flow unit 1604, configured to enable the first member to complete the fund flow event based on the fund flow route when all compliance check results of the fund flow event of all members in the fund flow route are qualified.

Optionally, the apparatus further includes: a result recording unit 1605, configured to enable the first member to initiate a compliance evidence deposit contract operation, to record the compliance check results of the fund flow event in a blockchain, where the fund flow unit 1604 is configured to enable the first member to complete the fund flow event based on the fund flow route when all compliance check results that are of the fund flow event of all members in the fund flow route and that are recorded in the blockchain are qualified.

Optionally, the apparatus further includes: a documents acquisition unit 1606, configured to enable the first member to obtain to-be-checked documents of the fund flow event; a digest recording unit 1607, configured to enable the first member to initiate a documents evidence deposit contract operation, to record a digital digest corresponding to the to-be-checked documents in a blockchain; and a documents pushing unit 1608, configured to enable the first member to push the to-be-checked documents to the at least two members, so that the at least two members perform the compliance check.

Optionally, a compliance check result provided by at least one member for the first member includes a digital digest corresponding to detailed data of a compliance check performed by the at least one member on the fund flow event, a determining result, and signature information of the at least one member; and the detailed data is recorded by the at least one member.

The system, apparatus, module, or unit illustrated in the previous implementations can be implemented by using a computer chip or an entity, or can be implemented by using a product having a certain function. A typical implementation device is a computer, and a specific form of the computer can be a personal computer, a laptop computer, a cellular phone, a camera phone, a smartphone, a personal digital assistant, a media player, a navigation device, an email receiving and sending device, a game console, a tablet computer, a wearable device, or any combination of these devices.

In a typical configuration, the computer includes one or more processors (CPU), an input/output interface, a network interface, and a memory.

The memory can include a non-persistent memory, a random access memory (RAM), a nonvolatile memory, and/or another form in a computer readable medium, for example, a read-only memory (ROM) or a flash memory. The memory is an example of the computer readable medium.

The computer readable medium includes persistent, non-persistent, movable, and unmovable media that can implement information deposit by using any method or technology. Information can be a computer readable instruction, a data structure, a program module, or other data. An example of a computer storage medium includes but is not limited to a phase-change random access memory (PRAM), a static random access memory (SRAM), a dynamic random access memory (DRAM), a random access memory (RAM) of another type, an ROM, an electrically erasable programmable read only memory (EEPROM), a flash memory or another memory technology, a compact disc read-only memory (CD-ROM), a digital versatile disc (DVD) or another optical storage, a cassette magnetic tape, a disk storage, a quantum memory, a graphene-based storage medium, another magnetic storage device, or any other non-transmission medium. The computer storage medium can be used to store information that can be accessed by a computing device. Based on the definition in the present specification, the computer readable medium does not include a transitory computer-readable medium (transitory medium), for example, a modulated data signal and carrier.

It is worthwhile to further note that the terms “include”, “comprise”, or their any other variant is intended to cover a non-exclusive inclusion, so that a process, a method, a product, or a device that includes a series of elements not only includes those elements but also includes other elements which are not expressly listed, or further includes elements inherent to such a process, a method, a product, or a device. An element preceded by “includes a . . . ” does not, without more constraints, preclude the existence of additional identical elements in the process, method, product, or device that includes the element.

Specific implementations of the present specification are described above. Other implementations fall within the scope of the appended claims. In some situations, the actions or steps described in the claims can be performed in an order different from the order in the implementation and the desired results can still be achieved. In addition, the process depicted in the accompanying drawings does not necessarily require a particular execution order to achieve the desired results. In some implementations, multi-tasking and parallel processing can be advantageous.

The terms used in the one or more implementations of the present specification are merely for the purpose of describing specific implementations, and are not intended to limit the one or more implementations of the present specification. The terms “a”, “said”, and “the” of singular forms used in the one or more implementations of the present specification and the appended claims are also intended to include plural forms, unless otherwise specified in the context clearly. It should also be understood that, the term “and/or” used in the present specification indicates and includes any or all possible combinations of one or more associated listed items.

It should be understood that although terms “first”, “second”, “third”, etc. can be used in the one or more implementations of the present specification to describe various types of information, the information is not limited to the terms. These terms are only used to differentiate information of the same type. For example, without departing from the scope of the one or more implementations of the present specification, first information can also be referred to as second information, and similarly, second information can also be referred to as first information. Depending on the context, for example, the word “if” used here can be explained as “while”, “when”, or “in response to determining”.

The previous descriptions are only example implementations of the one or more implementations of the present specification, but are not intended to limit the one or more implementations of the present specification. Any modification, equivalent replacement, improvement, etc. made without departing from the spirit and principle of the one or more implementations of the present specification shall fall within the protection scope of the one or more implementations of the present specification.

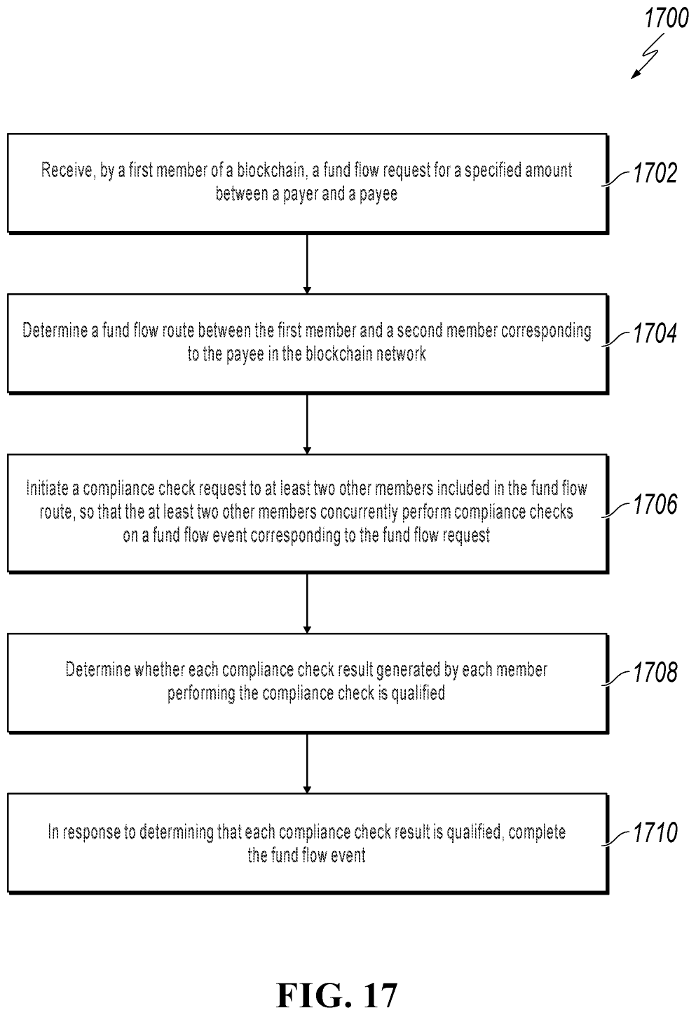

FIG. 17 is a flowchart illustrating an example of a computer-implemented method 1700 for processing a fund flow, according to an implementation of the present disclosure. For clarity of presentation, the description that follows generally describes method 1700 in the context of the other figures in this description. However, it will be understood that method 1700 can be performed, for example, by any system, environment, software, and hardware, or a combination of systems, environments, software, and hardware, as appropriate. In some implementations, various steps of method 1700 can be run in parallel, in combination, in loops, or in any order.

At 1702, a fund flow request for a specified amount between a payer and a payee is received by a first member of a blockchain. In some implementations, the blockchain is a consortium blockchain, and where each member included in the fund flow route is a node associated with the consortium blockchain. In such implementations, each member in the blockchain deposits a certain amount of blockchain balance at an anchor point, and wherein the anchor point is responsible for registering the blockchain balance deposit in the blockchain. From 1702, method 1700 proceeds to 1704.

At 1704, a fund flow route between the first member and a second member corresponding to the payee in the blockchain is determined, where the fund flow route includes the first member, the second member, and a number of relay members associated with the blockchain.

In some implementations, prior to determining the fund flow route, method 1700 further includes performing, by the first member, a compliance check on the fund flow event to generate a compliance check result. Whether the compliance check result is qualified is determined. In response to determining that the compliance check result is qualified, the fund flow route is determined by the first member. In response to determining that the compliance check result is unqualified, determining, by the first member, that the fund flow fails and terminating the fund flow event. From 1704, method 1700 proceeds to 1706.

At 1706, a compliance check request is initiated to at least two other members included in the fund flow route, so that the at least two other members concurrently perform compliance checks on a fund flow event corresponding to the fund flow request.

In some implementations, the first member initiating a compliance check request to at least two other members includes obtaining, by the first member, to-be-checked documents associated with the fund flow event; initiating a documents evidence deposit contract operation; recording a digital digest corresponding to the to-be-checked documents in the blockchain; and pushing the to-be-checked documents to the at least two other members to perform the compliance check.

In such implementations, method 1700 further comprises determining whether each generated compliance check result is qualified; in response to determining that at least one generated compliance check result is unqualified, requesting, by the first member, an initiator of the fund flow request to supplement documents; and pushing, by the first member, obtained supplementary documents to the member generated the at least one unqualified compliance check result to repeat the compliance check. From 1706, method 1700 proceeds to 1708.

At 1708, whether each compliance check result generated by each member performing the compliance check is qualified is determined. In some implementations, method 1700 further includes initiating, by the first member, a compliance evidence deposit contract operation to record the compliance check results associated with the fund flow event in the blockchain. From 1708, method 1700 proceeds to 1710.

At 1710, in response to determining that each compliance check result is qualified, the fund flow event is completed. After 1710, method 1700 stops.

Implementations of the present application can solve technical problems in data processing, specifically problems associated with fund flow processing. Traditionally, when a fund flow between a payer (for example, a user or an enterprise that pays funds) and a payee (for example, a user or an enterprise obtains the funds) involves several financial institutions, the financial institutions need to sequentially perform a compliance check on the fund flow event. Only one financial institution's failed compliance check can lead to a failure of the entire fund flow. Because different financial institutions may be located in different time zones, and each financial institution can determine its own fund flow processing procedures and requirements (for example, service fee, currency exchange rate, and information need to be provided), using traditional methods of processing a fund flow, especially a cross-border fund flow, can cause long processing times and result in extra service fees and other burdens to customers. Moreover, because many institutions are involved in the fund flow processing, there are many opportunities for leaks of customer privacy data due to multiple possible points of failure with respect to data security (for example, differing security methods, strengths, procedures, and tools). In addition, once a problem occurs in the process, it is hard to determine which institution should be held responsible for the problem. What is needed is a technique to bypass the problems with the conventional methods, and to provide a more secure and efficient solution for processing a fund flow. In this way, not only is the fund flow processing speed and data security is improved, but also an overall processing result can be considered to be more reliable and traceable for compliance/regulatory checks and service analysis.

Implementations of the present application provide methods and apparatuses for improving fund flow processing by joining institutions and users in a blockchain. According to these implementations, members of the blockchain join and authorize a smart contact on a fund payment service, so that the fund payment service for the members can be securely and automatically implemented based on the smart contract. The described subject matter provides several technical advantages. For example, before making a fund transfer, a fund flow route, and members included in the fund flow route are determined. Each member is a node in the blockchain and bound by the smart contract. Further, a member included in the fund flow route will initiate a compliance check request to other members included the fund flow route, so that the other members can improve data processing efficiency by, for example, concurrently performing compliance checks to avoid spending unnecessary processing time required with sequential compliance checks. Moreover, during a compliance check process, a data digest of the to-be-checked documents associated with each member can be stored in the blockchain and pushed to other members in the blockchain, so that each member can examine the to-be-checked documents to ensure the integrity and accuracy of the to-be-checked documents. By storing and examining the data digest (as opposed to an original copy of the to-be-checked documents), data privacy of each member can be better preserved. In addition, members of the blockchain can initiate a contract operation that is used for evidentiary deposit of compliance check results, where the compliance check results can be recorded in the blockchain. Because data stored in a blockchain block cannot be tampered with or modified, the recorded compliance check results can be considered to be reliable and trustworthy. The recorded compliance check results are also traceable even after the fund flow event is completed.

Embodiments and the operations described in this specification can be implemented in digital electronic circuitry, or in computer software, firmware, or hardware, including the structures disclosed in this specification or in combinations of one or more of them. The operations can be implemented as operations performed by a data processing apparatus on data stored on one or more computer-readable storage devices or received from other sources. A data processing apparatus, computer, or computing device may encompass apparatus, devices, and machines for processing data, including by way of example a programmable processor, a computer, a system on a chip, or multiple ones, or combinations, of the foregoing. The apparatus can include special purpose logic circuitry, for example, a central processing unit (CPU), a field programmable gate array (FPGA) or an application-specific integrated circuit (ASIC). The apparatus can also include code that creates an execution environment for the computer program in question, for example, code that constitutes processor firmware, a protocol stack, a database management system, an operating system (for example an operating system or a combination of operating systems), a cross-platform runtime environment, a virtual machine, or a combination of one or more of them. The apparatus and execution environment can realize various different computing model infrastructures, such as web services, distributed computing and grid computing infrastructures.

A computer program (also known, for example, as a program, software, software application, software module, software unit, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A program can be stored in a portion of a file that holds other programs or data (for example, one or more scripts stored in a markup language document), in a single file dedicated to the program in question, or in multiple coordinated files (for example, files that store one or more modules, sub-programs, or portions of code). A computer program can be executed on one computer or on multiple computers that are located at one site or distributed across multiple sites and interconnected by a communication network.

Processors for execution of a computer program include, by way of example, both general- and special-purpose microprocessors, and any one or more processors of any kind of digital computer. Generally, a processor will receive instructions and data from a read-only memory or a random-access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data. A computer can be embedded in another device, for example, a mobile device, a personal digital assistant (PDA), a game console, a Global Positioning System (GPS) receiver, or a portable storage device. Devices suitable for storing computer program instructions and data include non-volatile memory, media and memory devices, including, by way of example, semiconductor memory devices, magnetic disks, and magneto-optical disks. The processor and the memory can be supplemented by, or incorporated in, special-purpose logic circuitry.

Mobile devices can include handsets, user equipment (UE), mobile telephones (for example, smartphones), tablets, wearable devices (for example, smart watches and smart eyeglasses), implanted devices within the human body (for example, biosensors, cochlear implants), or other types of mobile devices. The mobile devices can communicate wirelessly (for example, using radio frequency (RF) signals) to various communication networks (described below). The mobile devices can include sensors for determining characteristics of the mobile device's current environment. The sensors can include cameras, microphones, proximity sensors, GPS sensors, motion sensors, accelerometers, ambient light sensors, moisture sensors, gyroscopes, compasses, barometers, fingerprint sensors, facial recognition systems, RF sensors (for example, Wi-Fi and cellular radios), thermal sensors, or other types of sensors. For example, the cameras can include a forward- or rear-facing camera with movable or fixed lenses, a flash, an image sensor, and an image processor. The camera can be a megapixel camera capable of capturing details for facial and/or iris recognition. The camera along with a data processor and authentication information stored in memory or accessed remotely can form a facial recognition system. The facial recognition system or one-or-more sensors, for example, microphones, motion sensors, accelerometers, GPS sensors, or RF sensors, can be used for user authentication.

To provide for interaction with a user, embodiments can be implemented on a computer having a display device and an input device, for example, a liquid crystal display (LCD) or organic light-emitting diode (OLED)/virtual-reality (VR)/augmented-reality (AR) display for displaying information to the user and a touchscreen, keyboard, and a pointing device by which the user can provide input to the computer. Other kinds of devices can be used to provide for interaction with a user as well; for example, feedback provided to the user can be any form of sensory feedback, for example, visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments can be implemented using computing devices interconnected by any form or medium of wireline or wireless digital data communication (or combination thereof), for example, a communication network. Examples of interconnected devices are a client and a server generally remote from each other that typically interact through a communication network. A client, for example, a mobile device, can carry out transactions itself, with a server, or through a server, for example, performing buy, sell, pay, give, send, or loan transactions, or authorizing the same. Such transactions may be in real time such that an action and a response are temporally proximate; for example an individual perceives the action and the response occurring substantially simultaneously, the time difference for a response following the individual's action is less than 1 millisecond (ms) or less than 1 second (s), or the response is without intentional delay taking into account processing limitations of the system.

Examples of communication networks include a local area network (LAN), a radio access network (RAN), a metropolitan area network (MAN), and a wide area network (WAN). The communication network can include all or a portion of the Internet, another communication network, or a combination of communication networks. Information can be transmitted on the communication network according to various protocols and standards, including Long Term Evolution (LTE), 5G, IEEE 802, Internet Protocol (IP), or other protocols or combinations of protocols. The communication network can transmit voice, video, biometric, or authentication data, or other information between the connected computing devices.

Features described as separate implementations may be implemented, in combination, in a single implementation, while features described as a single implementation may be implemented in multiple implementations, separately, or in any suitable sub-combination. Operations described and claimed in a particular order should not be understood as requiring that the particular order, nor that all illustrated operations must be performed (some operations can be optional). As appropriate, multitasking or parallel-processing (or a combination of multitasking and parallel-processing) can be performed.

What is claimed is:

1. A computer-implemented method, comprising:
receiving, by a first member of a blockchain, a fund flow request for a specified amount between a payer and a payee;
determining a fund flow route between the first member and a second member corresponding to the payee in the blockchain, wherein the fund flow route comprises the first member, the second member, and a plurality of relay members associated with the blockchain;
initiating a compliance check request to at least two other members included in the fund flow route, so that the at least two other members concurrently perform compliance checks on a fund flow event corresponding to the fund flow request;
determining whether each compliance check result generated by each member performing the compliance check is qualified; and
in response to determining that each compliance check result is qualified, completing the fund flow event.

2. The computer-implemented method of claim 1, further comprising:
prior to determining the fund flow route:
performing, by the first member, a compliance check on the fund flow event to generate a compliance check result; and
determining whether the compliance check result is qualified, wherein:
in response to determining that the compliance check result is qualified, determining, by the first member, the fund flow route; or
in response to determining that the compliance check result is unqualified, determining, by the first member, that the fund flow fails and terminating the fund flow event.

3. The computer-implemented method of claim 1, wherein the first member initiating the compliance check request to the at least two other members comprises:
obtaining, by the first member, to-be-checked documents associated with the fund flow event;
initiating a documents evidence deposit contract operation;
recording a digital digest corresponding to the to-be-checked documents in the blockchain; and
pushing the to-be-checked documents to the at least two other members to perform the compliance check.

4. The computer-implemented method of claim 3, further comprising:
determining whether each generated compliance check result is qualified;
in response to determining that at least one generated compliance check result is unqualified, requesting, by the first member, an initiator of the fund flow request to supplement documents; and
pushing, by the first member, obtained supplementary documents to the member generated the at least one unqualified compliance check result to repeat the compliance check.

5. The computer-implemented method of claim 1, wherein the blockchain is a consortium blockchain, and wherein each member included in the fund flow route is a node associated with the consortium blockchain.

6. The computer-implemented method of claim 1, wherein each member in the blockchain deposits a certain amount of blockchain balance at an anchor point, and wherein the anchor point is responsible for registering the blockchain balance deposit in the blockchain.

7. The computer-implemented method of claim 1, further comprising:
initiating, by the first member, a compliance evidence deposit contract operation to record the compliance check results associated with the fund flow event in the blockchain.

8. A non-transitory, computer-readable medium storing one or more instructions executable by a computer system to perform operations comprising:
receiving, by a first member of a blockchain, a fund flow request for a specified amount between a payer and a payee;
determining a fund flow route between the first member and a second member corresponding to the payee in the blockchain, wherein the fund flow route comprises the first member, the second member, and a plurality of relay members associated with the blockchain;
initiating a compliance check request to at least two other members included in the fund flow route, so that the at least two other members concurrently perform compliance checks on a fund flow event corresponding to the fund flow request;
determining whether each compliance check result generated by each member performing the compliance check is qualified; and
in response to determining that each compliance check result is qualified, completing the fund flow event.

9. The non-transitory, computer-readable medium of claim 8, further comprising:
prior to determining the fund flow route:
performing, by the first member, a compliance check on the fund flow event to generate a compliance check result; and
determining whether the compliance check result is qualified, wherein:
in response to determining that the compliance check result is qualified, determining, by the first member, the fund flow route; or
in response to determining that the compliance check result is unqualified, determining, by the first member, that the fund flow fails and terminating the fund flow event.

10. The non-transitory, computer-readable medium of claim 8, wherein the first member initiating the compliance check request to the at least two other members comprises:
obtaining, by the first member, to-be-checked documents associated with the fund flow event;
initiating a documents evidence deposit contract operation;
recording a digital digest corresponding to the to-be-checked documents in the blockchain; and
pushing the to-be-checked documents to the at least two other members to perform the compliance check.

11. The non-transitory, computer-readable medium of claim 10, further comprising:
determining whether each generated compliance check result is qualified;
in response to determining that at least one generated compliance check result is unqualified, requesting, by the first member, an initiator of the fund flow request to supplement documents; and
pushing, by the first member, obtained supplementary documents to the member generated the at least one unqualified compliance check result to repeat the compliance check.

12. The non-transitory, computer-readable medium of claim 8, wherein the blockchain is a consortium blockchain, and wherein each member included in the fund flow route is a node associated with the consortium blockchain.

13. The non-transitory, computer-readable medium of claim 8, wherein each member in the blockchain deposits a certain amount of blockchain balance at an anchor point, and wherein the anchor point is responsible for registering the blockchain balance deposit in the blockchain.

14. The non-transitory, computer-readable medium of claim 8, further comprising:
initiating, by the first member, a compliance evidence deposit contract operation to record the compliance check results associated with the fund flow event in the blockchain.

15. A computer-implemented system, comprising:
one or more computers; and
one or more computer memory devices interoperably coupled with the one or more computers and having tangible, non-transitory, machine-readable media storing one or more instructions that, when executed by the one or more computers, perform one or more operations comprising:
receiving, by a first member of a blockchain, a fund flow request for a specified amount between a payer and a payee;
determining a fund flow route between the first member and a second member corresponding to the payee in the blockchain, wherein the fund flow route comprises the first member, the second member, and a plurality of relay members associated with the blockchain;
initiating a compliance check request to at least two other members included in the fund flow route, so that the at least two other members concurrently perform compliance checks on a fund flow event corresponding to the fund flow request;
determining whether each compliance check result generated by each member performing the compliance check is qualified; and
in response to determining that each compliance check result is qualified, completing the fund flow event.

16. The computer-implemented system of claim 15, further comprising:
prior to determining the fund flow route:
performing, by the first member, a compliance check on the fund flow event to generate a compliance check result; and
determining whether the compliance check result is qualified, wherein:
in response to determining that the compliance check result is qualified, determining, by the first member, the fund flow route; or
in response to determining that the compliance check result is unqualified, determining, by the first member, that the fund flow fails and terminating the fund flow event.

17. The computer-implemented system of claim 15, wherein the first member initiating the compliance check request to the at least two other members comprises:
obtaining, by the first member, to-be-checked documents associated with the fund flow event;
initiating a documents evidence deposit contract operation;
recording a digital digest corresponding to the to-be-checked documents in the blockchain; and
pushing the to-be-checked documents to the at least two other members to perform the compliance check.

18. The computer-implemented system of claim 17, further comprising:
determining whether each generated compliance check result is qualified;
in response to determining that at least one generated compliance check result is unqualified, requesting, by the first member, an initiator of the fund flow request to supplement documents; and
pushing, by the first member, obtained supplementary documents to the member generated the at least one unqualified compliance check result to repeat the compliance check.

19. The computer-implemented system of claim 15, wherein the blockchain is a consortium blockchain, and wherein each member included in the fund flow route is a node associated with the consortium blockchain.

20. The computer-implemented system of claim 15, wherein each member in the blockchain deposits a certain amount of blockchain balance at an anchor point, and wherein the anchor point is responsible for registering the blockchain balance deposit in the blockchain.
